(19) United States
(12) Patent Application Publication
(10) Pub. No.: US 2011/0029280 A1
(43) Pub. Date: Feb. 3, 2011

(54) SENSING METHOD AND DEVICE UTILIZING ALTERNATING SIGNAL FREQUENCIES

(75) Inventors: Steef van Beckhoven, Eindhoven (NL); Mat Timmermans, Eindhoven (NL); Michel Klein Swormink, Eindhoven (NL)

Correspondence Address: WPAT, PC;INTELLECTUAL PROPERTY ATTORNEYS, 7225 BEVERLY ST., ANNANDALE, VA, 22003, US

(73) Assignee: LITE-ON IT CORP., Taipei City (TW)

(21) Appl. No.: 12/847,042

(22) Filed: Jul. 30, 2010

(30) Foreign Application Priority Data
Jul. 30, 2009 (CN) 200910160223.3

(51) Int. Cl. G01B 17/00

(52) U.S. Cl. 702/159

(57) ABSTRACT

An ultrasonic sensing method and an ultrasonic sensing device are provided. The ultrasonic sensing device includes a microprocessor, a signal-driving module and a transducer module. The microprocessor generates a first driving signal with a first frequency to the signal-driving module. The signal-driving module drives the transducer module to emit a first sensing signal to a target object in response to the first driving signal. Then, a first echo signal received by the transducer is transmitted to the microprocessor to calculate a first time of flight. In a similar manner, a second time of flight is obtained based on a second driving signal with a second frequency. The microprocessor determines a final time of flight according to the first time of flight or the second time of flight.

### FIELD OF THE INVENTION

The present invention relates to an ultrasonic sensing method and an ultrasonic sensing device, and more particularly to an ultrasonic sensing method and an ultrasonic sensing device utilizing alternating signal frequencies.

### BACKGROUND OF THE INVENTION

An ultrasonic sensing device is a widely applied device which emits ultrasonic waves. In recent applications, one type of ultrasonic sensing device has only emitter. That is, it generates the needed oscillating effect by emitting ultrasonic signals with specific frequency, but does not include receiving component. Another type of ultrasonic sensing device includes both designs of emitting ultrasonic signals and receiving echo signals. That is, the emitter and the receiver are both installed in the ultrasonic sensing device, and face the same direction to emit the ultrasonic signals and receive the echo signals. The ultrasonic sensing device can be used for measuring distance to a target object. Its design principle is to detect the traveling time of the ultrasonic signal which is emitted from the ultrasonic sensing device, reflected by the target object, and then sent back to the ultrasonic sensing device. The duration is so-called time of flight (TOF), which is usually used to determine a distance to a target object.

A known emitter of an ultrasonic sensing device is a piezoelectric element exerted thereon a driving voltage to generate ultrasonic signals or sensing signals by oscillation. For example, the driving signal has a frequency of about 40 KHz. The piezoelectric element generates the corresponding ultrasonic signals or sensing signals toward the target object upon receiving the driving signals. The sensing signals are then reflected by the target object so as to generate the echo signals, and further the echo signals are received by a receiver of the ultrasonic sensing device.

The above-mentioned emitter and receiver can be integrated into a transducer or a transducer module. To ensure that the received signals are echo signals obtained by reflection by the target object, but not background noise signals, several proposals include increasing amplitude of the emitted sensing signals and setting a threshold level for judging the received signals. For example, the threshold level is set to be about 1V or other default value. If the received signals do not reach the threshold level, they are determined as noise signals by the ultrasonic sensing device, but not the valid echo signals. Hence, the TOF cannot be determined and it judges that no target object is located within the sensing range.

FIG. 1A and FIG. 1B are schematic timing waveform diagrams illustrating the sensing signals emitted from and received by the conventional ultrasonic sensing device. In response to a driving signal with a constant frequency, a sensing signal TS with a specific amplitude is emitted at time t1. In FIG. 1A, an echo signal ES whose amplitude just reaches the set threshold level L is received at time t2. Hence, it is determined that the echo signal ES is a valid echo signal from a target object, and the TOF is defined as time period from t1 to t2, i.e. TOF=t2−t1. On the contrary, in FIG. 1B, the right wave does not reach the set threshold level L, and it is determined as noise signal. Hence, no echo signal is received and calculation of TOF fails.

However, the surface property, external profile, or moving status of the target object may cause interference during the wave reflection, and it is possible that the echo signal has a decaying amplitude and is erroneously determined as a noise signal. Thus, the target object is not detectable by this ultrasonic sensing device. FIG. 2A and FIG. 2B illustrate the possible misjudging situations. The target object to be sensed by the ultrasonic sensing device 10 in FIG. 2A has a plate 11 with a thickness variation. If the left reflected wave and the right reflected wave form destructive interference due to phase difference, the amplitude of the echo signal is seriously reduced and the detection result is affected. On the other hand, the target object in FIG. 2B has a curved surface 12. The reflected waves from different points of the target object also form destructive interference as described above. Hence, it is possibly that the echo signal with reduced amplitude is determined as noise signal and no TOF is obtained.

Besides, the sensing signal generated by the ultrasonic sensing device may have different transmission intensity toward different direction. The relation between the transmission intensity and the emitting angle can be shown by a known polar plot. Hence, for some sensing direction, the corresponding echo signal has weaker amplitude. Furthermore, the emitted signal may be a non-homogeneous signal so that the amplitude of the echo signal varies with the detection angle. It also affects the detection result. In fact, it is impossible to require that the target object is located at the best sensing position or located within the best sensing angle range. Therefore, there is a need of providing a more reliable sensing device and method for obtaining a TOF to solve the problems.

### SUMMARY OF THE INVENTION

The present invention provides a reliable sensing method used with an ultrasonic sensing device which can sense a target object regardless of influence of the status of the target object.

The present invention also provides a reliable ultrasonic sensing device which can sense a target object regardless of influence of the status of the target object.

In accordance with an aspect of the present invention, a sensing method is provided. At first, a first driving signal with a first frequency is generated. A first sensing signal is emitted to the target object in response to the first driving signal, and the target object reflects the first sensing signal to generate a first echo signal received by a transducer module. Then, a second driving signal with a second frequency is generated. A second sensing signal is emitted to the target object in response to the second driving signal, and the target object reflects the second sensing signal to generate a second echo signal received by the transducer module. According to the received first echo signal and second echo signal, a first time of flight and a second time of flight are acquired, respectively. At last, a microprocessor determinates a final time of flight according to the first time of flight or the second time of flight.

In an embodiment, the first frequency is different from the second frequency.

In accordance with another aspect of the present invention, an ultrasonic sensing device is provided. The ultrasonic sensing device includes a microprocessor, a signal-driving module and a transducer module. At first, the microprocessor generates and transmits a first driving signal with a first frequency to the signal-driving module. The signal-driving module drives the transducer module to emit a first sensing signal to the target object in response to the first driving signal, and the target object reflects the first sensing signal to generate a first echo signal received by the transducer module. Then, in a similar manner, the microprocessor generates and transmits a second driving signal with a second frequency to the signal-driving module. The signal-driving module drives the transducer module to emit a second sensing signal to the target object in response to the second driving signal, and the target object reflects the second sensing signal to generate a second echo signal received by the transducer module. The microprocessor calculates a first time of flight and a second time of flight according to the first echo signal and the second echo signal, respectively, and then determinates a final time of flight according to the first time of flight or the second time of flight.

### BRIEF DESCRIPTION OF THE DRAWINGS

The above contents of the present invention will become more readily apparent to those ordinarily skilled in the art after reviewing the following detailed description and accompanying drawings, in which:

FIGS. 1A and 1B are schematic timing waveform diagrams illustrating the ultrasonic signals emitted from and received by a conventional ultrasonic sensing device;

FIGS. 2A and 2B are schematic diagrams illustrating possible misjudging situations of the conventional ultrasonic sensing device;

FIG. 3 is a schematic functional block diagram illustrating an ultrasonic sensing device according to a preferred embodiment of the present invention;

FIG. 4A is a schematic timing diagram illustrating driving signals generated with alternating frequencies provided in the ultrasonic sensing device of FIG. 3;

FIG. 4B is a schematic timing diagram illustrating the ultrasonic signals and the corresponding echo signals while sensing a target object according to the present invention; and

FIG. 5 is a flowchart illustrating a sensing method according to a preferred embodiment of the present invention.

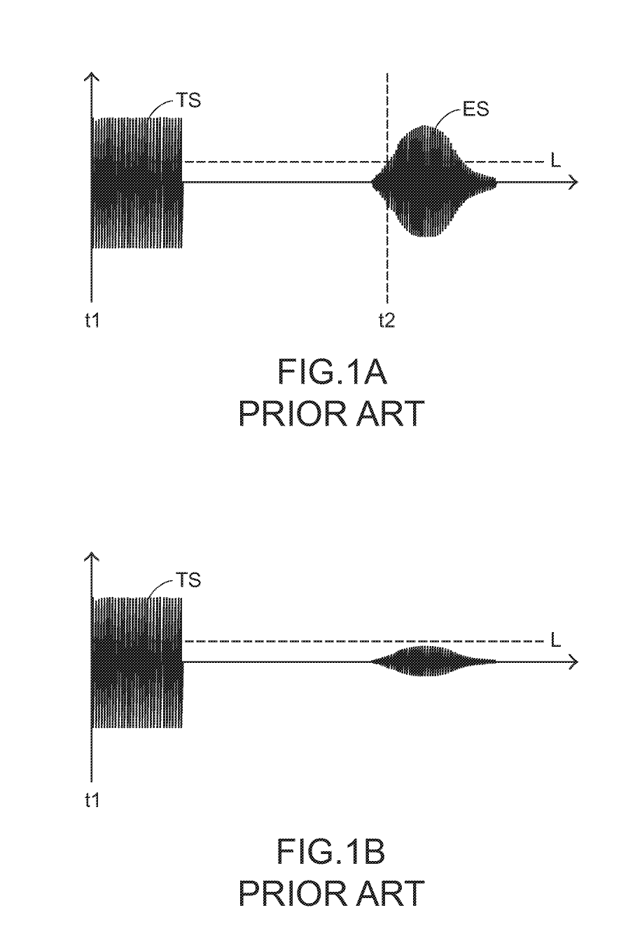

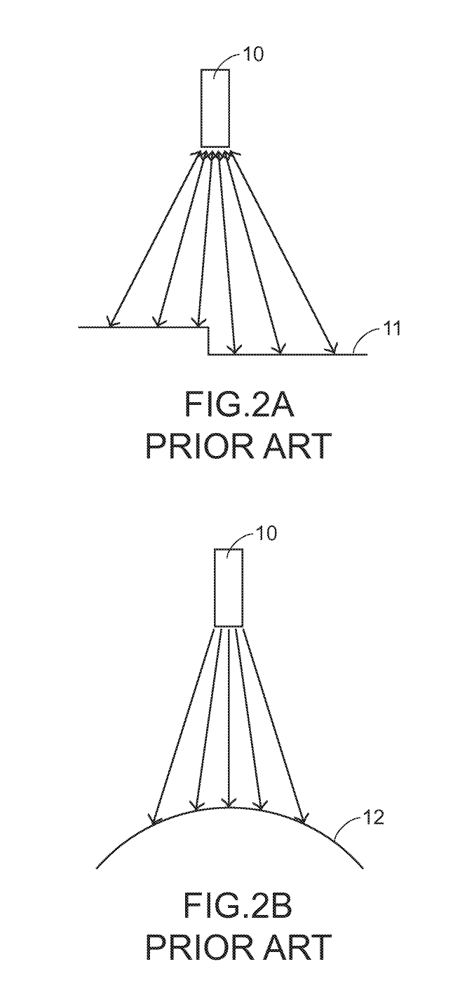

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

As described above, the surface property, external profile, or moving status of the target object, or the transmission characteristic of the sensing signal may affect the amplitude of the echo signal and the estimation of the TOF for calculating the distance to the target object. According to the prior art, the driving signal is usually provided with a fixed frequency, for example 40 KHz to generate the sensing signal with a specific frequency. The fixed frequency is associated with the resonance frequency of the piezoelectric element. In general, the influence of the surface property, external profile, or moving status of the target object, or the transmission characteristic of the sensing signal varies with the frequency of the driving signal.

Although a valid echo signal is not generated when the sensing signal is generated in response to the driving signal with a first frequency, a valid echo signal may be obtained if the driving signal has a second frequency because the influence may be eliminated. Hence, a driving signal with multiple frequencies may lead to valid echo signal. That is, when the optimal frequency of the driving signal is unknown for a specific target object, multiple frequencies are attempted. If one of the multiple frequencies cannot obtain a satisfactory detection result, another one of the multiple frequencies is then adopted to provide different detection result which may compensate for the undetectable effect for the previous frequency.

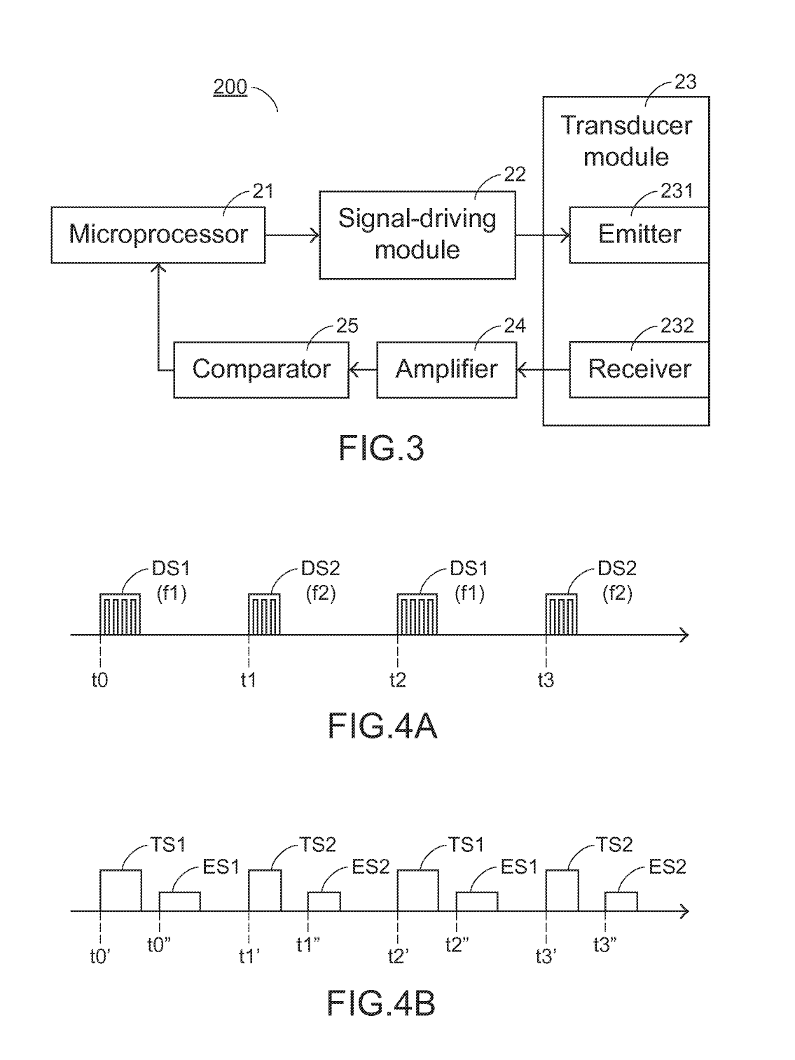

FIG. 3 is a schematic functional block diagram illustrating an ultrasonic sensing device according to a preferred embodiment of the present invention. The ultrasonic sensing device 200 includes a microprocessor 21, a signal-driving module 22, a transducer module 23, an amplifier 24, and a comparator 25. The transducer module 23 includes an emitter 231 and a receiver 232 for emitting sensing signals and receiving echo signals, respectively. In an embodiment, the emitter 231 and the receiver 232 are integrated into a single unit capable of emitting and receiving signals. The communication relationship between each component is also illustrated in the drawing. The ultrasonic sensing device 200 according to the present invention can be applied to measuring the distance to a target object (not shown). The design of the ultrasonic sensing device 200 takes advantage of driving signals with alternating frequencies to generate corresponding sensing signals with different frequencies.

FIG. 4A is a schematic timing diagram illustrating driving signals with alternating frequencies provided in the ultrasonic sensing device 200. In this embodiment, a first frequency f1 is different from a second frequency f2, and the two frequencies f1 and f2 are alternately used. It is to be noted that the driving signals are not limited to square waves shown in the drawing. Triangular waves, sine waves or other waves with suitable waveform are applicable. The first frequency f1 and the second frequency f2 are controllable by the microprocessor 21 via a programming software or a chip design manner, and the driving period is also determined by the microprocessor 21.

In this embodiment, the microprocessor 21 generates the first driving signal DS1 with the first frequency f1 at time t0 and the second driving signal DS2 with the second frequency f2 at time t1. Then, the first driving signal DS1 and the second driving signal DS2 are repeatedly generated at time t2 and time t3, respectively. The same driving signal sequence is repeated during the whole sensing operation. The time interval between any two adjacent driving signals may be adjusted by the microprocessor 21. The time interval may vary, but in this embodiment, all the time intervals (t0 to t1, t1 to t2, t2 to t3, . . . ) are identical.

FIG. 4B is a schematic timing diagram illustrating the sensing signals generated in response to the driving signals of FIG. 4A and the corresponding echo signals. The signal-driving module 22 drives the emitter 231 of the transducer module 23 in response to the driving signals DS1 and DS2 to correspondingly emit a first sensing signal TS1 and a second sensing signal TS2 at time t0′ and t1′, respectively. The first sensing signal TS1 and the second sensing signal TS2 are alternately generated during the subsequent operation.

The signal-driving module 22 according to the present invention drives the emitter 231 to emit sensing signals in response to the driving signals issued by the microprocessor 21, and amplifies the driving signals to enhance amplitude of the sensing signals. Since the signal transmission speed is very fast, sometimes the time t0′, t1′, t2′ and t3′ are considered as equivalent to the time t0, t1, t2 and t3.

As mentioned above, the first sensing signal TS1 and the second sensing signal TS2 are alternately emitted from the emitter 231. Then, each sensing signal is reflected by the target object to generate corresponding echo signal. In this embodiment, the first echo signal ES1 corresponds to the first sensing signal TS1, and the second echo signal ES2 corresponds to the second sensing signal TS2. The first echo signal ES1 and the second echo signal ES2 are received by the receiver 232 of the transducer module 23.

As mentioned above, the time intervals of the driving signals can be adjusted. The time intervals are adjusted according to a predicted TOF to ensure that the next sensing signal is issued after the previous echo signal is received to prevent signal interference. As shown in FIG. 4B, after the first sensing signal TS1 is emitted, the corresponding first echo signal ES1 is received at time t0″, and then the second sensing signal TS2 is emitted at time t1′. After the second echo signal ES2 is received at time t1″, the next first sensing signal TS1 is emitted and so on.

Since the amplitude of the echo signal will decay with traveling distance, the echo signals ES1 and ES2 are amplified by the amplifier 24 after reception by the receiver 232 for later judgment. A threshold level is set to judge whether the received signal is a valid echo signal or a noise signal. The comparator 25 compares the amplified echo signals ES1 and ES2 with the threshold level. Then the two echo signals ES1 and ES2 are transmitted to the microprocessor 21 to determine the TOF. In another embodiment, the function of the comparator 25 is integrated into the microprocessor 21, so that the microprocessor 21 needs to perform the comparison and determination of the TOF.

After the first echo signal ES1 and the second echo signal ES2 are transmitted to the microprocessor 21, the microprocessor 21 can calculate the TOF according to the emitting time of each sensing signal and the receiving time of the corresponding echo signal. In this embodiment, as illustrated in FIG. 4B, the first time of flight TOF1 is the duration between the emitting time t0′ of the first sensing signal TS1 and the receiving time t0″ of the first echo signal ES1, and the second time of flight TOF2 is the duration between the emitting time t1′ of the second sensing signal TS2 and the receiving time t1″ of the second echo signal ES2. The first time of flight TOF1 and the second time of flight TOF 2 are the detection results corresponding to the driving signals with the first frequency f1 and the second frequency f2.

According to the prior arts, the status of the target object or the signal emitting condition may make the detection result unreliable or instable and cause failure in calculation of TOF. If the affected echo signal does not reach the threshold level, the echo signal is determined as noise signal even thought the echo signal in a signal plot shows a complete echo waveform. The receiving time or the TOF cannot be successfully acquired by the conventional ultrasonic sensing device.

On the contrary, according to the present invention, the microprocessor 21 may select a proper TOF from at least two detected TOFs associated with sensing signals with different frequencies. When at least two TOFs are detected based on different frequencies, it is almost impossible that all of the detected TOFs are invalid or undetectable. Hence, it increases the possibility to successfully acquire the correct TOF by slightly changing the frequency of the driving signal.

For example, the first frequency f1 is 40 KHz for acquiring the first time of flight TOF1, and the second frequency f2 is 45 KHz for acquiring the second time of flight TOF2. When TOF1 is judged invalid due to improper frequency (40 KHz), the next detection based on 45 KHz may effectively acquire the TOF at the previous undetectable position or angle. Thus, TOF2 is adopted to calculate the distance. Otherwise, TOF1 is adopted if the TOF2 is considered invalid.

Referring back to FIG. 4B, in an embodiment, the microprocessor 21 can determine the final TOF according to the receiving time t0″ of the first echo signal ES1 and the receiving time t1″ of the second echo signal ES2. In another embodiment, the microprocessor 21 can determine the final TOF according to the receiving time t1″ of the second echo signal ES2 and the receiving time t2″ of the first echo signal ES1. In a further embodiment, the microprocessor 21 can determine the final TOF according to the receiving time t0″ of the first echo signal ES1 and the receiving time t3″ of the second echo signal ES2.

As mentioned above, the microprocessor 21 selects one TOF from the two detected TOFs as the final TOF. If one detected TOF is valid and the other one is invalid, the microprocessor 21 has to select the valid one. However, if both the detected TOFs are valid, the microprocessor 21 may have another choice. In principle, the calculated distances based on the two TOFs should be very close. Hence, the microprocessor 21 may select the greater TOF, the smaller TOF, or an average (mean value) of both as the final TOF according to the setting or requirements to calculate the distance between the ultrasonic sensing device 200 and the target object.

In another embodiment, three driving signals are adopted wherein each driving signal has an individual frequency. The operation and principle are similar to the embodiments as described above. The microprocessor 21 issues a first driving signal with a first frequency, a second driving signal with a second frequency, and a third driving signal with a third frequency in sequence. Thus, three sensing signals and three corresponding echo signals are generated. After compared with the threshold level, more than one valid TOF is obtained. The microprocessor 21 may determine the final TOF by selecting one valid TOF or performing a logic operation on the more than one valid TOF, for example average. In practice, the number of the driving signals with different frequencies may be adjusted to meet one's requirements.

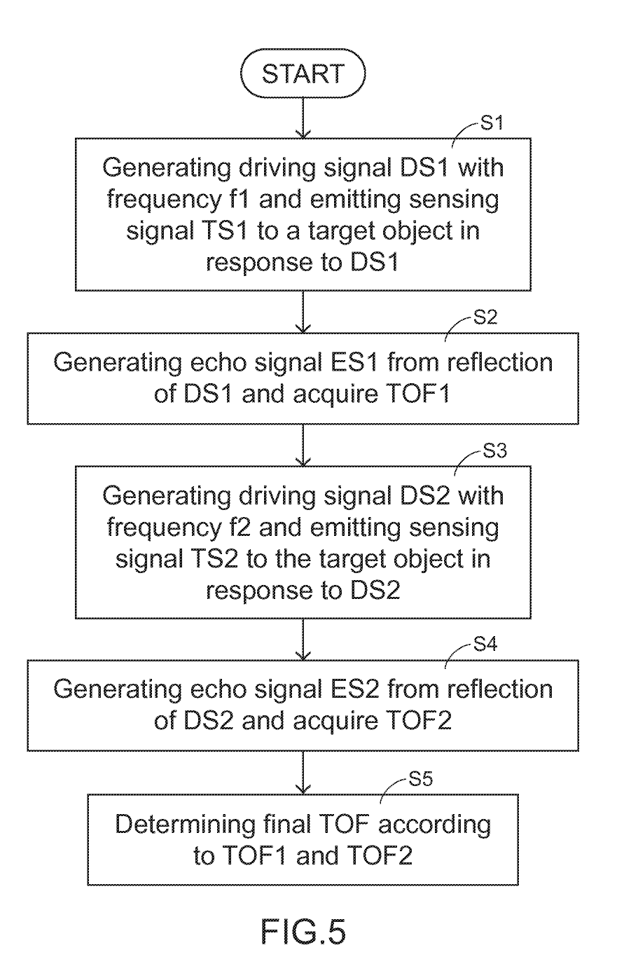

FIG. 5 is a flowchart illustrating a sensing method according to the present invention. At first, the microprocessor 21 generates the first driving signal DS1 with the first frequency f1. The signal-driving module 22 drives the transducer module 23 to emit the first sensing signal TS1 to the target object in response to the first driving signal DS1 (Step S1). Then, the first echo signal ES1 generated from the reflection of the first sensing signal TS1 is received by the transducer module 23 and transmitted to the microprocessor 21. The microprocessor 21 calculates the first time of flight TOF1, i.e. the duration between the emitting time t0′ of the first sensing signal TS1 and the receiving time t0″ of the first echo signal ES1 (Step S2). In a similar manner, the microprocessor 21 generates the second driving signal DS2 with the second frequency f2. The signal-driving module 22 drives the transducer module 23 to emit the second sensing signal TS2 to the target object in response to the second driving signal DS2 (Step S3). The second echo signal ES2 generated from the reflection of the second sensing signal TS2 is received by the transducer module 23 and then transmitted to the microprocessor 21. The microprocessor 21 calculates the second time of flight TOF2, i.e. the duration between the emitting time t1′ of the second sensing signal TS2 and the receiving time t1″ of the second echo signal ES2 (Step S4). Finally, the microprocessor 21 determines the final TOF according to the first time of flight TOF1 and the second time of flight TOF2 to calculate the distance to the target object (Step S5).

In conclusion, the present invention can perform valid sensing even though the status of the target object may influence the detection result for specific frequency driving. By providing driving signals with alternating frequencies, the influence is successfully overcome. Compared with the prior arts, the present invention just needs to provide the microprocessor for generating driving signals with alternating frequencies while no additional element is required. Thus, the ultrasonic sensing device provides more reliable detection without increasing the production cost.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sensing method used with an ultrasonic sensing device including a microprocessor, a signal-driving module and a transducer module, the sensing method comprising steps of:
generating a first driving signal with a first frequency by the microprocessor;
emitting a first sensing signal by the transducer module to a target object in response to the first driving signal;
receiving a first echo signal generated from the first sensing signal by the transducer module;
calculating a first time of flight by the microprocessor according to the first echo signal;
generating a second driving signal with a second frequency by the microprocessor;
emitting a second sensing signal by the transducer module to the target object in response to the second driving signal;
receiving a second echo signal generated from the second sensing signal by the transducer module;
calculating a second time of flight by the microprocessor according to the second echo signal; and
determining a final time of flight according to the first time of flight and the second time of flight by the microprocessor.

2. The sensing method according to claim 1 wherein the first frequency is different from the second frequency.

3. The sensing method according to claim 1, further comprising a step of determining a distance between the ultrasonic sensing device and the target object according to the final time of flight.

4. The sensing method according to claim 1, further comprising steps of:
amplifying the first driving signal to drive the signal-driving module to generate the first sensing signal; and
amplifying the second driving signal to drive the signal-driving module to generate the second sensing signal.

5. The sensing method according to claim 1, further comprising steps of:
amplifying the first echo signal and the second echo signal;
comparing the amplified first echo signal with a threshold level to determine the first echo signal as a first valid echo signal when the amplified first echo signal has an amplitude greater than the threshold level; and
comparing the amplified second echo signal with the threshold level to determine the second echo signal as a second valid echo signal when the amplified second echo signal has an amplitude greater than the threshold level.

6. The sensing method according to claim 5 wherein the microprocessor determines the final time of flight according to the first valid echo signal or the second valid echo signal.

7. The sensing method according to claim 1, further comprising steps of:
generating a third driving signal with a third frequency by the microprocessor;
emitting a third sensing signal by the transducer module to a target object in response to the third driving signal;
receiving a third echo signal generated from the third sensing signal by the transducer module;
calculating a third time of flight by the microprocessor according to the third echo signal; and
determining the final time of flight according to the first time of flight, the second time of flight or the third time of flight by the microprocessor.

8. The sensing method according to claim 7 wherein the first frequency, the second frequency and the third frequency are different from each other.

9. The sensing method according to claim 1 wherein the microprocessor determines the final time of flight by a logic operation on the first time of flight and the second time of flight.

10. The sensing method according to claim 9 wherein the microprocessor determines the final time of flight according to a smaller time of flight, a greater time of flight or a average time of flight of the first time of flight and the second time of flight.

11. An ultrasonic sensing device comprises:
a microprocessor generating a first driving signal with a first frequency and a second driving signal with a second frequency in sequence;
a signal-driving module in communication with the microprocessor, for receiving the first driving signal and the second driving signal; and
a transducer module in communication with the signal-driving module, to be driven by the signal-driving module for emitting a first sensing signal to a target object in response to the first driving signal and emitting a second sensing signal to the target object in response to the second driving signal, and receiving a first echo signal corresponding to the first sensing signal and a second echo signal corresponding to the second sensing signal from the target object;
wherein the microprocessor calculates a first time of flight according to the first echo signal, calculates a second time of flight according to the second echo signal, and determines a final time of flight according to the first time of flight and the second time of flight.

12. The ultrasonic sensing device according to claim 11 wherein the first frequency is different from the second frequency.

13. The ultrasonic sensing device according to claim 11 wherein the microprocessor determines a distance between the ultrasonic sensing device and the target object according to the final time of flight.

14. The ultrasonic sensing device according to claim 11 wherein the signal-driving module amplifies the first driving signal and the second driving signal to drive the transducer module to generate the first sensing signal and the second sensing signal.

15. The ultrasonic sensing device according to claim 11, further comprises:
an amplifier in communication with the transducer module, for amplifying the first echo signal and the second echo signal; and
a comparator in communication with the amplifier for comparing the amplified first echo signal with a threshold level to determine the first echo signal as a first valid echo signal when the amplified first echo signal has an amplitude greater than the threshold level, and comparing the amplified second echo signal with the threshold level to determine the second echo signal as a second valid echo signal when the amplified second echo signal has an amplitude greater than the threshold level.

16. The ultrasonic sensing device according to claim 15 wherein the microprocessor determines the final time of flight according to the first valid echo signal or the second valid echo signal.

17. The ultrasonic sensing device according to claim 11 wherein the microprocessor generates a third driving signal with a third frequency; the transducer module is driven to emit a third sensing signal in response to the third driving signal and receives a third echo signal from the target object; and the microprocessor calculates a third time of flight according to the third echo signal and determines the final time of flight according to the first time of flight, the second time of flight or the third time of flight.

18. The ultrasonic sensing device according to claim 17 wherein the first frequency, the second frequency and the third frequency are different from each other.

19. The ultrasonic sensing device according to claim 11 wherein the microprocessor determines the final time of flight by a logic operation on the first time of flight and the second time of flight.

20. The ultrasonic sensing device according to claim 19 wherein the microprocessor determines the final time of flight according to a smaller time of flight, a greater time of flight or a average time of flight of the first time of flight and the second time of flight.

21. An ultrasonic sensing method comprising steps of:
alternately emitting at least two sensing signals with different frequencies;
respectively receiving at least two echo signals corresponding to the sensing signals with different frequencies;
determining each of the echo signals is valid or not; and
determining a final time of flight according to at least one of the valid echo signals.

22. The ultrasonic sensing method according to claim 21, wherein one of the echo signals is determined as the valid echo signal if the echo signal has an amplitude greater than a threshold level.

23. The ultrasonic sensing method according to claim 21, wherein the final time of flight is determined by a logic operation on the valid echo signals.
